(19) United States
(12) Patent Application Publication
(10) Pub. No.: US 2012/0218116 A1
(43) Pub. Date: Aug. 30, 2012

(54) Position Monitoring System And Method Of Use

(76) Inventor: Ronnie Tatum, Ripley, MS (US)

(21) Appl. No.: 13/035,046

(22) Filed: Feb. 25, 2011

(51) Int. Cl. G08B 21/00

(52) U.S. Cl. 340/688

(57) ABSTRACT

A position monitoring system comprising a casing which attaches to an item and a locator chip which inserts into the casing; a distance monitoring unit, where the distance monitoring unit houses a global positioning device which monitors a location of the locator chip; a display screen on a front face of the distance monitoring unit, where said display screen shows the location of the locator chip; a dial attached to the front face of the distance monitoring unit; a range of distances displayed radially around the dial, where an individual distance determines a radius for a circular boundary around the distance monitoring unit and where the dial turns to the individual distance to set the radius for the circular boundary; and a speaker attached to the distance monitoring unit, wherein the speaker sounds an alarm to alert a user when the locator chip leaves the circular boundary.

### BACKGROUND OF THE INVENTION

1. Field of the Invention

The present invention relates to a position monitoring system which alerts a user when an item leaves a predetermined area and then determines the location of the object utilizing a global positioning device.

2. Description of Related Art

Parents are continuously concerned with the safety and wellbeing of their children. Especially when the children are away, the parents worry and hope that no harm with come to the kids. Parents and guardians may take precautionary steps by gathering information about where the child will be and who will be with them. Additionally, the parents may have a system with the child where the child checks in, either in person or by phone, to inform the parents of their whereabouts and where they are going. Problems arise if the child gets lost or is taken. The parents are left helpless to the location of the child except for following the clues left behind at the moments before the child went missing.

Some devices have been developed to assist a parent to monitor the location of their child. The most basic is a leash and harness device, wherein a harness is attached around the body of the child and a leash strapped to the harness is held by the parent. This physically connects the child and parent to prevent the child from leaving a small perimeter around the parent. Some technology advances have been made as well. For example, U.S. Pat. No. 5,617,074 by Marvin D. White discloses a child finder wherein a child wears a transmitter typically concealed within a piece of jewelry like a wristwatch. The transmitter submits a signal to a receiving unit that continuously monitors the location of the child. Furthermore, U.S. Pat. No. 6,388,612 by Timothy J. Neher discloses a global cellular position tracking device wherein a child wears a bracelet that is tracked at a central monitoring station using a global positioning system. The bracelet includes a way to send a distress signal, either by pushing a button or it is automatically triggered when the bracelet is removed, to the monitoring station which then sends the appropriate law enforcement officials to rescue the child. A problem with this device is that it does not include a handheld monitoring device to allow the parent to also monitor the location of the child.

It would be desirable in the art to provide a child monitoring system which allows a parent to monitor the location of their child using a global positioning system. It would also be beneficial in the art to provide a child monitoring system which allows the parent to create a boundary within which the child must remain otherwise an alarm is sound to alert the parent as to the child's whereabouts.

### SUMMARY OF THE INVENTION

In view of the foregoing disadvantages inherent in the prior art, the purpose of the present disclosure is to provide a position monitoring system which alerts a user when an item leaves a predetermined area and then determines the location of the object utilizing a global positioning device.

An object of the present invention is to provide an item monitoring system which utilizes a locator chip attached to the item wherein when the item leave a predetermined boundary a user is alerted as to the location of the item through a global positioning device housed within a distance monitoring unit.

Another object of the present invention is to provide an item monitoring device which further includes a screen to displays the real time position of where the item is located.

To achieve the above objects, in an aspect of the present invention, a position monitoring system comprising a casing which attaches to an item and a locator chip which inserts into the casing; a distance monitoring unit, where the distance monitoring unit houses a global positioning device which monitors a location of the locator chip; a display screen on a front face of the distance monitoring unit, where said display screen shows the location of the locator chip; a dial attached to the front face of the distance monitoring unit; a range of distances displayed radially around the dial, where an individual distance determines a radius for a circular boundary around the distance monitoring unit and where the dial turns to the individual distance to set the radius for the circular boundary; and a speaker attached to the distance monitoring unit, wherein the speaker sounds an alarm to alert a user when the locator chip leaves the circular boundary.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 (A) depicts a perspective view of a casing and a locator chip in accordance with an exemplary embodiment of the present invention; and

FIG. 1 (B) depicts a perspective view of a distance monitoring unit in accordance with an exemplary embodiment of the present invention.

### DETAILED DESCRIPTION OF THE DRAWINGS

The present invention relates to a position monitoring system which alerts a user when an item leaves a predetermined area and then determines the location of the object utilizing a global positioning device. The position monitoring system includes a locating chip which attaches to an item and a distance monitoring unit to track the position of the locating chip. When the locating chip goes beyond a predetermined circular boundary an alarm sounds within the distance monitoring unit to alert a user. The user then determines the location of the locating chip by viewing a screen on the distance monitoring unit which displays the global position of the locating chip. More than one locating chip may be used at a time with the position monitoring system and each may be identified with different symbols on the screen. The position monitoring system is especially useful for parents to monitor their children and determine their location in case of an emergency.

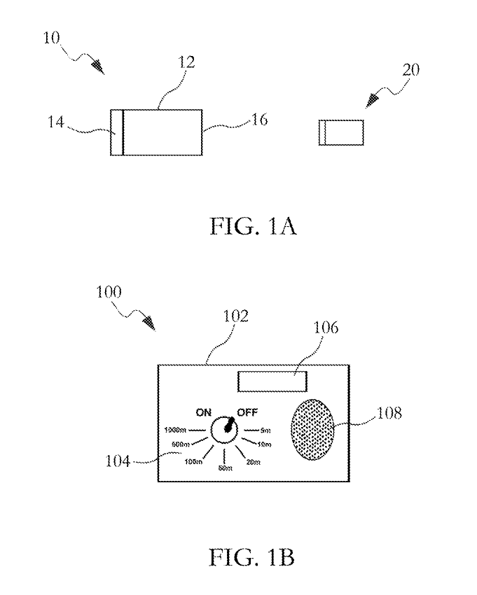

Tuning now descriptively to the drawings, referring to FIG. 1 (A), a perspective view of a casing (10) and a locator chip (20) is shown in accordance with an exemplary embodiment of the present invention. The casing (10) provides a protective covering for the locator chip (20). The locator chip (20) includes an identification code specific to each individual locator chip which coordinates with a global positioning system to identify the location of the locator chip (20). This way more than one locator chip (20) may be used each with their own casing (10).

The locator chip (20) inserts into the casing (10) by sliding through an opening (14) on a side portion of the casing (10). The locator chip (20) then rests against an end (16) on an opposing side of the casing (10) from the opening (14). After the locator chip (20) is inserted into the casing (10) the opening (14) folds over and secures the locator chip (20) against the end (16). The locator chip (20) may be comprised of carbon materials that are both water and fire resistant to ensure that the locator chip (20) remains functional regardless of possible hazardous conditions.

The casing (10) may comprise a small and portable envelope style covering, approximately the size of an adhesive bandage. The casing (10) includes an attachment means wherein a user is able to stick the casing (10) onto an item, for example an individual's skin, clothing, belt, shoe, purse, backpack, hat or other common items typically used and worn by an individual. Additionally, the casing (10) may be fastened to the collar, harness or clothing of an animal or pet. The attachment means may be a hook and loop fastener, an iron-on backing or an adhesive coating to ensure that the casing (10) remains with the individual and prevents the casing (10) from falling off during movement.

Referring to FIG. 1 (B), a perspective view of a distance monitoring unit (100) is shown in accordance with an exemplary embodiment of the present invention. The distance monitoring unit (100) includes a housing (102) to contain all of the electrical and mechanical components. Specifically, within the housing (102) is a global positioning device which enables the distance monitoring unit (100) to track the location of the locator chip (20). The housing (102) may be small enough to be a handheld device or larger to provide a device that rest on a desk or countertop.

On the front face of the housing (102) is a dial (104). The dial (104) twists to point to a range of distance markings. The range of distance markings are arranged radially around the dial (104), and are marked clockwise in an increasing order. The dial (104) twists from an off position, wherein the dial (104) points to the off marking, to an on position, wherein the dial moves past the on marking to a specific distance marking The range of markings corresponds to the distance from the distance monitoring unit (100) the locator chip (20) may travel before an alarm is sounded. Essentially, the specific distance markings relate to a radius of a circular boundary or perimeter. For example, when the dial (104) is turned to the 100 m marking the radius of the circular boundary is 100 m and likewise when the dial (104) is turned to the 800 m marking the radius of the circular boundary is 800 m. When the locator chip (20) is within the circular boundary the distance monitoring unit (100) is silent, but when it leaves the circular boundary the alarm sounds.

Positioned above the dial (104) along an upper portion of the front face of the housing (102) is a display screen (106). The display screen (106) reflects the global position of the locator chip (20) as monitored by the internal global positioning device. The location of the locator chip (20) may be viewed at all times while the distance monitoring unit (100) is on. Located next to the display screen (106) is a speaker (108) which sounds the alarm when the global positioning device detects that the locator chip (20) has traveled beyond the circular boundary. The alarm may sound a continuous ringing or buzzing noise or it may sound a pulsing noise. A mute button or a reset button may be assembled on the housing (102) to enable the user to quiet the alarm after it sounds.

The combination of the casing (10) with the encased locator chip (20) and the distance monitoring unit (100) comprise a position monitoring system. During use, the user attaches the casing (10) with the locator chip (20) to the person, animal or object to be monitored. Next, the user activates the distance monitoring unit (100) by twisting the dial (104) past the on marking and turning the dial (104) to the specific distance marking which corresponds to the predetermined circular boundary. The global positioning device within the housing (102) receives a signal specific to the identification code within the locator chip (20). If more than one locator chip (20) is used each signal is displayed on the display screen (106) as a different symbol. While the locator chip (20) remains within the circular boundary the distance monitoring unit (100) is silent. When the locator chip (20) exits the circular boundary the alarm sounds to alert the user. The user then views the display screen (106) to determine the exact location of the locator chip (20). The position monitoring system is especially useful in emergency situation to allow a parent, guardian or law enforcement locate a lost or stolen child. The position monitoring system is also beneficial for the user to monitor and generally maintain real time supervision on the locator chip (20).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A position monitoring system comprising:
a casing, where said casing attaches to an item;
a locator chip, where said locator chip is inserted into said casing;
a distance monitoring unit, where said distance monitoring unit houses a global positioning device which monitors a location of said locator chip;
a display screen on a front face of said distance monitoring unit, where said display screen shows said location of said locator chip as monitored by said global positioning device;
a dial attached to said front face of said distance monitoring unit;
a range of distances displayed radially around said dial, where an individual distance determines a radius for a circular boundary around said distance monitoring unit and where said dial turns to said individual distance to set said radius for said circular boundary; and
a speaker attached to said distance monitoring unit, wherein said speaker sounds an alarm to alert a user when said locator chip leaves said circular boundary.

2. The distance monitoring system according to claim 1, wherein said casing includes an attachment means to fasten said locator chip to said item,

3. The distance monitoring system according to claim 2, wherein said attachment means is at least one of a hook and loop fastener, an iron-on backing and an adhesive coating.

4. The distance monitoring system according to claim 1, wherein said housing is handheld.

5. The distance monitoring system according to claim 1, wherein said housing rests upon a desk.

6. The distance monitoring system according to claim 1, wherein said distance monitoring unit includes a mute button to quiet said alarm.

7. The distance monitoring system according to claim 1, wherein more than one locator chip is monitored by said distance monitoring unit at one time.

8. A method of use for a distance monitoring system comprising the steps of:
attaching a locator chip to an item;
activating said distance monitoring unit by twisting a dial to a specific distance marking to create a circular boundary around said distance monitoring unit;
determining a location of said locator chip using a global positioning device within said distance monitoring unit after an alarm sounds when said locator chip exits said circular boundary; and
viewing said location of said locator chip by viewing a screen on a front face of said distance monitoring unit.

9. The method of use for the distance monitoring system according to claim 8 further comprising the step of placing said locator chip within a casing and then attaching said casing to said item.

10. The method of use for the distance monitoring system according to claim 8 further comprising the step of monitoring said locator chip by viewing said screen even when said locator chip is within said circular boundary.
